(19) United States
(12) Patent Application Publication
(10) Pub. No.: US 2011/0248492 A1
(43) Pub. Date: Oct. 13, 2011

(54) SECURITY DEVICE WITH AT LEAST ONE DURABLE TACTILE MARKING

(76) Inventors: John B. Kittredge, Windsor, MA (US); Kraig M. Brigham, Lenox, MA (US); Daniel G. Leeds, Manchester, NH (US); Paul F. Cote, Hollis, NH (US); Gregory R. Jordan, Cumming, GA (US); James L. Little, Roswell, GA (US)

(21) Appl. No.: 13/124,346

(22) PCT Filed: Oct. 14, 2009
(86) PCT No.: PCT/US2009/005597

§ 371 Date: Jun. 29, 2011

Related U.S. Application Data
(60) Provisional application No. 61/196,469, filed on Oct. 17, 2008.

(51) Int. Cl. B42D 15/00

(52) U.S. Cl. 283/81

(57) ABSTRACT

A security device having at least one durable tactile marking (16) in the form of one or more relief structures is provided. The one or more relief structures are selected from the group of elastically deformable relief structures, relatively compression-resistant relief structures, and combinations thereof. Also provided is a fibrous or non-fibrous sheet material (10) with at least one durable tactile marking, which is suitable for use in making secure and non-secure documents or labels. The tactile marking (s) is applied directly to a surface of the sheet material, or is provided by way of the above-described security device (s), which is mounted on a surface of the sheet material and/or at least partially embedded therein. The durable tactile marking (s) serves to provide a visually challenged person with information concerning the type and/or value of the secure or non-secure document or label.

### RELATED APPLICATION

This application claims priority to U.S. Provisional Patent Application Ser. No. 61/196,469, filed Oct. 17, 2008, which is incorporated herein in its entirety by reference.

### TECHNICAL FIELD

The present invention generally relates to durable tactile markings for use on or within documents or labels, and more particularly relates to durable tactile markings in the form of one or more elastically deformable relief (raised) structures and/or one or more relatively compression-resistant relief structures.

### BACKGROUND AND SUMMARY OF THE INVENTION

People with little or no functional vision have difficulty determining the denominational value or identity of secure documents such as banknotes. Such visually challenged individuals must therefore rely upon other means to denominate or identify such documents, such as portable readers designed for the particular document in question.

Several attempts have been made in the past to address this difficulty by providing different means for identification that are integral to the document. For example, the Dutch 10 Guilder notes that issued in 1997 have a series of embossed chevron patterns down the short edges of the notes, while Canadian banknotes have a series of raised dots located in an upper right corner of the face side of the bill that serve to indicate denomination.

Unfortunately, these embossments are not sufficiently durable and once the banknotes are in circulation the embossments soon become permanently compressed and thus non-tactile.

A need therefore exists for durable tactile markings that resist the effects of circulation.

The present invention serves to address this need by providing durable tactile markings in the form of one or more relief structures selected from the group of elastically deformable relief structures, relatively compression-resistant relief structures, and combinations thereof.

In an exemplary embodiment, the one or more relief structures are elastically deformable relief structures. The term “elastically deformable”, as used herein, means that the relief structures will substantially return to their original shape upon removal of a compressive force.

Preferably, the elastically deformable relief structures of the present invention are substantially transparent or clear relief structures, which have a Durometer 00 (Shore 00) hardness of at least about 50, or switching to the Durometer A (Shore A) scale, a hardness of less than about 100 (more preferably, from about 30 to less than about 100 Shore A, and most preferably, from about 50 to about 80 Shore A), and a Young's Modulus of from about 0.3 to about 13.8 megapascals (MPa) (50-2000 psi) (more preferably, from about 0.6 to about 10.3 MPa (100-1500 psi), and most preferably, from about 1.0 to about 3.4 MPa (150-500 psi)).

More preferably, the substantially transparent or clear, elastically deformable relief structures are thermoplastic polyurethane relief structures.

In another exemplary embodiment, the one or more relief structures are relatively compression-resistant relief structures. The term “relatively compression-resistant”, as used herein, means that the relief structures will resist compression and substantially maintain their original shape when exposed to a compressive force.

Preferably, the relatively compression-resistant relief structures of the present invention are substantially transparent or clear relief structures, which have a Durometer A (Shore A) hardness of at least about 80, and a Young's Modulus of from about 3.4 to about 173 MPa (500-25,000 psi) (more preferably, from about 7.0 to about 103.4 MPa (1000-15,000 psi), and most preferably, from about 13.8 to about 48.2 MPa (2,000-7,000 psi)).

More preferably, the substantially transparent or clear, relatively compression-resistant relief structures are thermosetting urethane-acrylate relief structures.

The present invention also provides a security device in the form of, for example, a strip or band, thread, or patch, which comprises at least one of the above-described durable tactile markings.

The present invention further provides a fibrous or non-fibrous sheet material with at least one durable tactile marking, which is suitable for use in making secure and non-secure documents or labels, wherein the tactile marking(s) is applied directly to a surface of the sheet material, or is provided by way of the above-described security device(s), which is mounted on a surface thereof and/or at least partially embedded therein.

Documents made from the above-described fibrous or non-fibrous sheet material are also provided by way of the present invention. The documents include secure documents such as banknotes, bonds, checks, traveler's checks, identification cards, lottery tickets, passports, postage stamps, and stock certificates, as well as non-secure documents such as labels.

Other features and advantages of the invention will be apparent to one of ordinary skill from the following detailed description and accompanying drawings. Unless otherwise defined, all technical and scientific terms used herein have the same meaning as commonly understood by one of ordinary skill in the art to which this invention belongs. All publications, patent applications, patents and other references mentioned herein are incorporated by reference in their entirety. In case of conflict, the present specification, including definitions, will control. In addition, the materials, methods, and examples are illustrative only and not intended to be limiting.

### BRIEF DESCRIPTION OF THE DRAWINGS

The present disclosure may be better understood with reference to the following drawings. Matching reference numerals designate corresponding parts throughout the drawings, and components in the drawings are not necessarily to scale, emphasis instead being placed upon clearly illustrating the principles of the present disclosure. While exemplary embodiments are disclosed in connection with the drawings, there is no intent to limit the present disclosure to the embodiment or embodiments disclosed herein. On the contrary, the intent is to cover all alternatives, modifications and equivalents.

Particular features of the disclosed invention are illustrated by reference to the accompanying drawings, in which:

FIG. 1 is an enlarged, cross-sectional, diagrammatic side view of one exemplary embodiment of the fibrous sheet material of the present invention, the sheet material having an exemplary embodiment of the inventive security device in the form of a thread fully embedded therein, the durable tactile markings on the device being tactilely discernible from opposing surfaces of the sheet material;

FIGS. 2(A)-2(C) are cross-sectional side views of a further exemplary embodiment of the security thread of the present invention in the form of a micro-optic film structure with tactile markings positioned on one or opposing sides of this structure;

FIGS. 3(A)-3(E) are plan views of a front or upper surface of further exemplary embodiments of the security thread of the present invention with durable tactile markings made up of: a raised standard Braille code denoting the numeral 100 and a raised numeral 100 (see FIG. 3(A)); a raised code based on full blocks of Braille cells denoting the numeral 100 and a raised numeral 100 (see FIG. 3(B)); a raised Moon code denoting the numeral 100 (see FIG. 3(C)); a series of regularly spaced raised lines, with each raised line extending across the entire width of the security thread (see FIG. 3(D)); and a pattern of regularly spaced pairs of raised lines, with each raised line extending across the entire width of the security thread (see FIG. 3(E));

FIG. 4 is a plan view of a front or upper surface of one exemplary embodiment of the fibrous sheet material of the present invention, which has one prior art security thread partially embedded therein and one exemplary embodiment of the inventive security thread fully embedded therein, the fully embedded thread's durable tactile markings being tactilely discernible from opposing surfaces of the sheet material;

FIG. 5(A) is a plan view of a front or upper surface of another exemplary embodiment of the inventive fibrous sheet material, the sheet material employing an embodiment of the inventive security thread which combines tactile markings with other security features (e.g., optically variable security features) on opposing surfaces of the thread, the other security features being visible in clearly defined windows on the sheet material's upper surface, the tactile markings being tactilely discernible to an extent on this surface, while FIG. 5(B) is a plan view of a back or lower surface of the sheet material shown in FIG. 5(A) in which the tactile markings are tactilely discernible to a much greater extent on this surface; and

FIG. 6 is a plan view of an upper surface of yet another exemplary embodiment of the inventive fibrous sheet material, the sheet material employing another embodiment of the inventive security thread, which combines tactile markings with other security features but on the same surface of the thread, the other security features being visible in clearly defined windows on the sheet material's upper surface, while the tactile markings are tactilely discernable from the upper surface, and to a lesser extent, from a lower surface of the sheet material.

### BEST MODE FOR CARRYING OUT THE INVENTION

The durable tactile markings offered by way of the present invention serve to provide a visually challenged person with information concerning the type and/or value of a secure or non-secure document or label. The durable tactile markings, which are tactilely accessible on both surfaces of the document or label, may adopt any shape, form or pattern that either intentionally or unintentionally might assist a visually challenged user in handling these documents. By way of example, the durable tactile markings may be a simple linearly arranged or localized pattern of raised dots, ridges and/or lines, or a more complex standard Braille pattern, a pattern based only on full blocks of Braille cells (6 dots), a pattern based on the Moon System of Embossed Reading, or the like.

As noted above, the tactile markings described herein are either elastically deformable or relatively compression-resistant. When employed on or within multiple-use documents, such as banknotes, the tactile markings will resist the effects of circulation, assuring that these markings continue to provide visually challenged individuals with a means for discerning the type and/or value of these documents.

The invention will now be described in detail below with reference to the drawings which illustrate different exemplary embodiments of the invention.

Referring now to FIG. 1, one exemplary embodiment of the fibrous sheet material of the present invention is shown generally at 10. Fully embedded within fibrous sheet material 10 is a security device 12, which basically comprises a substrate 14 and one durable tactile marking 16 in the form of a plurality of elastically deformable and/or relatively compression-resistant relief structures 18, which are positioned on one surface of substrate 14, and which are tactilely discernible on both surfaces of fibrous sheet material 10. As will be readily appreciated, where these relief structures are accessible on both surfaces of the sheet material, orientation of the inventive device 12 within the fibrous sheet material 10 may not be important, which is a marked advantage over surface-applied security devices.

When more than one durable tactile marking 16 is used, these markings may be the same or different and may be located on one or opposing sides of substrate 14. When located on opposing sides of substrate 14, the tactile markings 16 may or may not be in register with each other.

The security device 12 may further comprise, as a separate or integrated feature, one or more visually apparent and/or machine detectable/readable security features, coatings, or layers; provided any such additional security feature, coating, or layer does not interfere with the tactile perception of the durable tactile marking(s). Contemplated additional security features, coatings, or layers include, but are not limited to, luminescent, color shift, magnetic, metal or metallic, non-metallic conductive, and micro-optic security features, sealing or obscuring layers, outer protective layers, and adhesive layers that facilitate incorporation of device 12 into or onto secure or non-secure documents.

In one such exemplary embodiment, security device 12 is a film material having metal and/or magnetic security features (e.g., metal and/or magnetic graphic indicia in the form of letters, numbers, or symbols)) integrated or combined with the durable tactile marking(s) 16. By way of example, the durable tactile marking(s) 16 may be placed on a surface of substrate 14 opposite that surface containing the metal and/or magnetic graphic indicia, or may be placed on the same surface as the metal and/or magnetic graphic indicia in free or unoccupied areas, or may be placed directly on at least some of the graphic indicia. When placed directly on at least some of the graphic indicia, the tactile marking(s) 16 is preferably substantially transparent or clear.

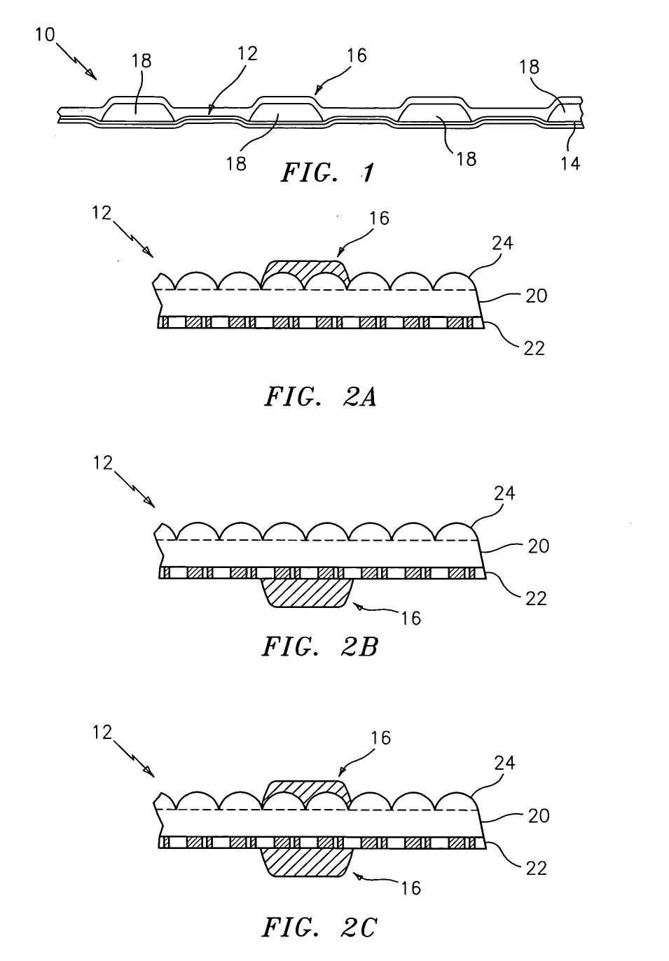

In another such exemplary embodiment, as shown in FIGS. 2(A)-2(C), security device 12 is a micro-optic film material for projecting synthetic images that integrates or combines the durable tactile marking(s) 16 with the micro-optic security feature. Micro-optic film materials for projecting synthetic images are known and generally comprise (a) a light-transmitting polymeric substrate 20, (b) an arrangement of image icons 22 located on or within the polymeric substrate 20, and (c) an arrangement of image icon focusing elements (e.g., microlenses) 24. The icon and microlens arrangements 22, 24 are configured such that when the arrangement of icons is viewed through the arrangement of microlenses, one or more synthetic images are projected. These projected images may show a number of different optical effects. Such film materials are described in U.S. Pat. No. 7,333,268 to Steenblik et al., U.S. Pat. No. 7,468,842 to Steenblik at al., U.S. Patent Application Publication No. 2008/0037131 to Steenblik et al., International Patent Publication No. WO 2005/106601 A2 to Commander et al., International Patent Publication No. WO 2007/076952 A2 to Kaule et al.; International Patent Publication No. WO 2009/000527 to Kaule et al.; International Patent Publication No. WO 2009/000528 to Kaule et al.; International Patent Publication No. WO 2009/000529 to Kaule et al.; and International Patent Publication No. WO 2009/000530 to Kaule.

In this exemplary embodiment, the at least one durable tactile marking 16 may be positioned directly on the microlens arrangement 24, as best shown in FIG. 2(A), directly on the icon arrangement 22, as best shown in FIG. 2(B), or directly on opposing surfaces of the film material, as best shown in FIG. 2(C).

While not required for purposes of this invention, substrate 14 of security device 12 is preferably a light-transmitting and essentially colorless polymer film selected from the group including, but not limited to, polyester, polyethylene, polyethylene terephthalate, polypropylene, polyvinyl carbonate, polyvinylidene chloride, and combinations thereof. The thickness of the polymer film used for substrate 14 preferably ranges from about 12 to about 26 microns (more preferably from about 13 to about 17 microns).

In one contemplated embodiment, substrate 14 is a polyester film that has been surface treated to improve the adhesion of further coatings. Polyester films that have been surface treated for enhanced adhesion are available from a number of suppliers including E.I. du Pont de Nemours and Company, Mitsubishi Chemical USA, Inc., Nuroll SpA, and Toray Industries, Inc.

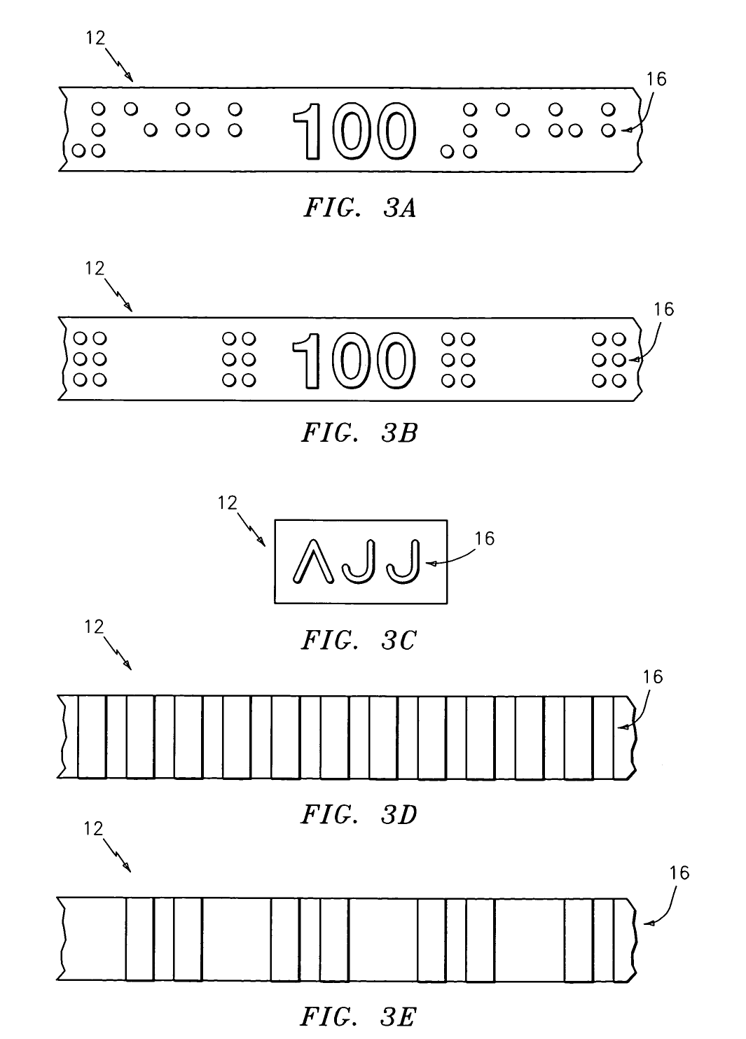

As noted above, the durable tactile marking(s) 16 may adopt any shape, form or pattern that might assist a visually challenged user in handling both secure and non-secure documents or labels. By way of example, and as best shown in FIG. 3, the tactile markings 16 may take the form of: a standard Braille pattern combined with a numerical designation, as shown in FIG. 3(A); a pattern based only on full blocks of Braille cells (6 dots) combined with a numerical designation, as shown in FIG. 3(B); a pattern based on the Moon System of Embossed Reading, as shown in FIG. 3(C); a pattern employing regularly spaced raised lines, as shown in FIG. 3(D); or a pattern of regularly spaced pairs of raised lines, as shown in FIG. 3(E).

Each relief structure in durable tactile marking 16 will have a preferred relief of less than about 250 microns. In a more preferred embodiment, each relief structure has a relief ranging from about 60 to about 240 microns (most preferably, from about 80 to about 200 microns).

Elastically deformable relief structures may be formed using elastomers such as polyester, polyethylene, polypropylene, polystyrene, polyurethane, synthetic rubber (e.g., BUNA, NEOPRENE), or any other elastic material.

As noted above, in a preferred exemplary embodiment, the elastically deformable relief structures are substantially transparent or clear structures having a to Durometer 00 (Shore 00) hardness of at least about 50, or a Durometer A (Shore A) hardness of less than about 100 (more preferably, from about 30 to less than about 100 Shore A, and most preferably, from about 50 to about 80 Shore A), and a Young's Modulus of from about 0.3 to about 13.8 megapascals (MPa) (50-2000 psi) (more preferably, from about 0.6 to about 10.3 MPa (100-1500 psi), and most preferably, from about 1.0 to about 3.4 MPa (150-500 psi)).

As also noted above, in a more preferred exemplary embodiment, the substantially transparent or clear relief structures are thermoplastic polyurethane relief structures. A suitable polyurethane material for use in forming these structures is a polyurethane resin, which is available from Bayer MaterialScience AG, Leverkusen Germany.

Relatively compression-resistant relief structures may be formed using substantially transparent or clear radiation curable resins including, but not limited to, acrylics, acrylated polyesters, acrylated urethanes, polyesters, polypropylenes, and urethanes.

As noted above, in a preferred embodiment, the relatively compression-resistant relief structures are substantially transparent or clear structures having a Durometer A (Shore A) hardness of at least about 80, and a Young's Modulus of from about 3.4 to about 173 MPa (500-25,000 psi) (more preferably, from about 7.0 to about 103.4 MPa (1000-15,000 psi), and most preferably, from about 13.8 to about 48.2 MPa (2,000-7,000 psi)).

In a more preferred exemplary embodiment, the substantially transparent or clear relief structures are thermosetting urethane-acrylate relief structures. A suitable UV-curable, urethane-acrylate resin composition for use in forming these structures is available from Lord Corporation under the product designation U107.

The elastomers and radiation curable materials described above may advantageously contain other additives, some of which may function as either a visually accessible or machine detectable/readable security feature. Contemplated additives include (but are not limited to) UV absorbers, luminescent materials (e.g., phosphorescent, fluorescent, bioluminescent materials), color shift, magnetic, metal or metallic, non-metallic conductive materials, and combinations thereof.

In one contemplated embodiment, the elastomer or radiation curable material includes an effective amount of fluorescent pigment particles.

The security device 12 of the present invention, when employing elastically deformable tactile markings, may be prepared using one of a number of techniques, including the three techniques described below.

A first technique involves the use of a laminated sheet (i.e., an elastomer sheet laminated to substrate 14 (e.g., a polyurethane sheet laminated to a polyester web)) and counter-rotating, hot and cool rollers disposed in a side-by-side relationship. The cool roller has one or more patterns of tactile markings 16 engraved into a surface (preferably, a non-stick surface) in a cross-machine direction to a depth of less than about 250 microns, the width of each pattern preferably ranging from about 0.05 to about 2.5 millimeters. Such cross-machine engravings may extend around the circumference of the roller or may be spaced in a repeating pattern, for example, to differentiate currency denominations. The hot roller (e.g., a stainless steel or rubber roller) is set at a temperature to soften the elastomer.

In operation, the laminated sheet is passed between the two rollers causing the elastomer sheet to soften and become amenable to patterning by the cool roller, thereby resulting in the formation of tactile marking(s) 16.

A second technique, which is similar to the one described above, employs molten elastomer and a substrate 14 in the form of, for example, a polyester web, instead of a laminated sheet. Here, molten elastomer is dispensed to a gap between the counter-rotating hot and cold rollers, with the molten elastomer being cast from the recesses of the cold roller onto the polyester web as it passes between the rollers, thereby resulting in the formation of tactile marking(s) 16.

A third technique involves a 2-stage process in which an elastomer sheet (with a silicone liner) is passed between a first pair of counter-rotating rollers (e.g., a steel anvil and a patterned rotary die) disposed in a side-by-side relationship, where the elastomer sheet is patterned to form a plurality of relief structures. The patterned sheet is then passed through a second pair of counter-rotating rollers (e.g., patterned hot transfer die and rubber impression cylinder) where it is brought into contact with substrate 14 (e.g., a polyester web). Here, select relief structures are transferred onto the polyester web, thereby forming tactile marking(s) 16.

The security device 12 of the present invention, when employing relatively compression-resistant tactile markings, is preferably prepared using a radiation cured casting process. In one such process, a pattern of tactile markings 16 is engraved into a surface of a gravure cylinder (e.g., a stainless steel or nickel or gold plated gravure cylinder) and the engraved cylinder placed in a rotary type printing press.

In operation, substrate film 14 having an upper side (preferably, an upper side that has been surface treated for enhanced adhesion) is continuously advanced past a casting station. A fluid radiation curable resinous material is cast on a continuous basis onto the upper side of the substrate film 14 from the casting station. The resulting cast-coated film is then brought into contact with the engraved gravure cylinder and pushed against it causing the resinous material to move into and fill the recessed areas on the cylinder, which results in the formation of the tactile marking(s) 16. While in contact with the cylinder, the film is exposed to a source of radiation (e.g., ultraviolet light or electron beam irradiation) that serves to cure the resin, thereby causing the resin to retain the shape of the tactile marking(s) 16. As the film advances, the tactile marking(s) 16 cleanly separates from the recessed areas on the cylinder.

Once prepared, the film structure can be cut or slit to any shape or size. In one contemplated embodiment, the film is slit to provide narrow threads which are at least 0.8 mm in width, preferably from about 1 to about 5 mm, or even up to 6 or 8 mm in width.

The security device 12 in the form of a security thread may be at least partially incorporated in fibrous sheet materials such as security papers during manufacture by techniques commonly employed in the papermaking industry. For example, the inventive security thread may be pressed within wet paper fibers while the fibers are unconsolidated and pliable, as taught by U.S. Pat. No. 4,534,398, resulting in the thread being totally embedded in the resulting paper. The thread may also be partially embedded within the body of the finished paper (i.e., windowed paper) by using, for example, a cylinder mold papermaking machine, cylinder vat machine, or similar machine of known type.

In addition to the above, the security device 12 in the form of, for example, a security patch, may be mounted on a surface of a fibrous or non-fibrous sheet material either during or post manufacture. Mounting of the device may be achieved by any number of known techniques including: applying a pressure-sensitive adhesive to a surface of the device and pressing the device to the surface of the sheet material; and applying a heat activated adhesive to a surface of the device and applying the device, using thermal transfer techniques, to the surface of the material.

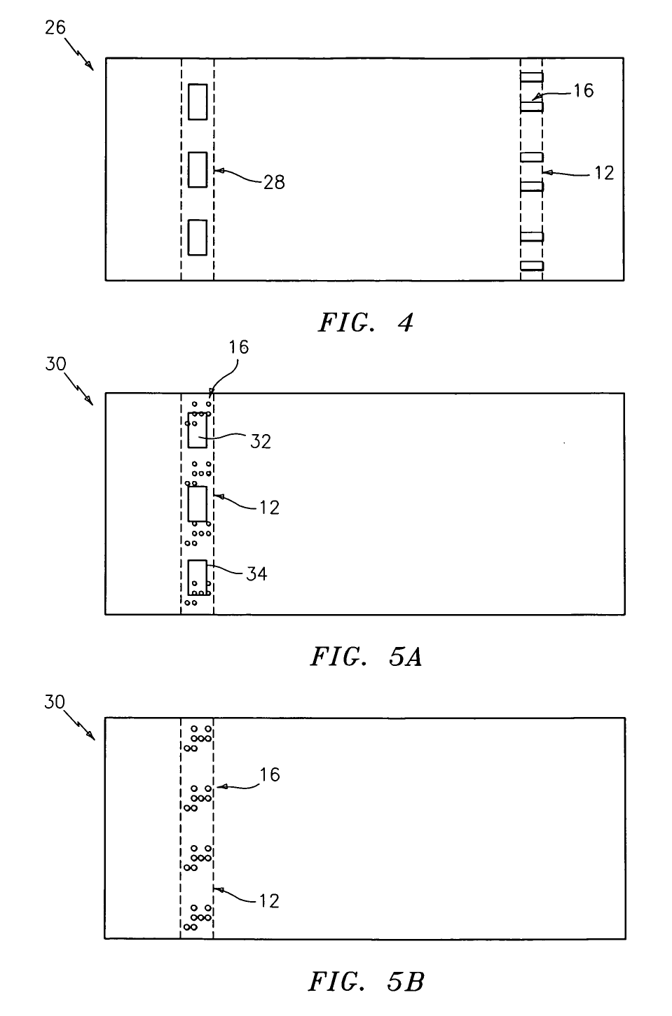

In FIG. 4, reference numeral 26 is used to denote another exemplary embodiment of the fibrous sheet material of the present invention. As shown, fibrous sheet material 26 has one prior art security thread 28 partially embedded therein and one exemplary embodiment of the inventive security thread 12 fully embedded therein, the thread's durable tactile markings 16 being tactilely discernible from both sides of the sheet material.

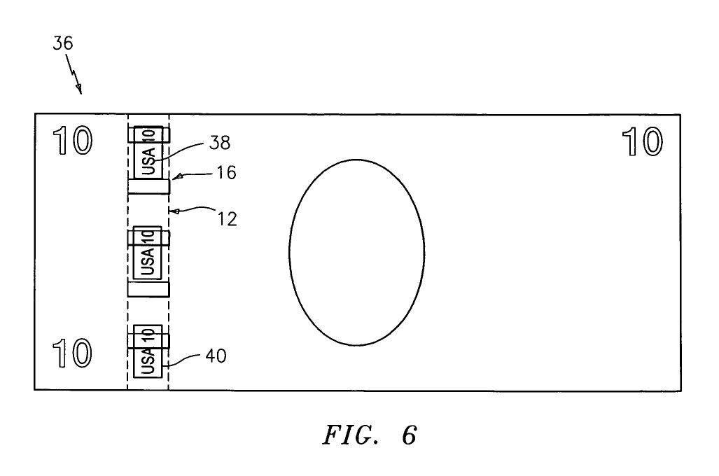

In FIG. 5, reference numeral 30 is used to denote another exemplary embodiment of the inventive fibrous sheet material. As shown, fibrous sheet material 30 has one embodiment of the inventive security thread 12 partially embedded therein, the thread combining tactile markings 16 with other security features 32 (e.g., optically variable security features such as those described in U.S. Pat. No. 7,333,268 to Steenblik et al.) on opposing surfaces of the thread. As best shown in FIG. 5(A), the other security features 32 are visible in clearly defined windows 34 on the sheet material's front or upper surface, the tactile markings 16 being tactilely discernible to an extent on this surface, while in reference to FIG. 5(B), the tactile markings 16 are tactilely discernible to a much greater extent on the sheet material's back or lower surface.

As noted above, the fibrous or non-fibrous sheet material of the present invention may be used to prepare both secure and non-secure documents including banknotes, bonds, checks, traveler's checks, identification cards, lottery tickets, passports, postage stamps, and stock certificates, and labels.

One embodiment of a banknote made in accordance with the teachings of the present invention is shown in FIG. 6, and denoted by reference numeral 36. Here, a windowed security thread 12 combines tactile markings 16 with other security features 38 (i.e., metal indicia) on the same surface of the thread, the metal indicia 38 being visible in clearly defined windows 40 on the banknote's surface, while the tactile markings 16 are tactilely discernable on opposing surfaces of the banknote.

The tactile markings of the present invention either return to substantially their original shape after a compressive force is removed or resist flattening under compression altogether and therefore constitute a reliable means for visually challenged individuals to discern the type and/or value of documents employing these markings.

As will be readily appreciated by those skilled in the art, to minimize any distortion of the sheet material or stack of sheets caused by the inclusion of durable tactile marking(s) 16, the security device 12 may be oscillated within the sheet material by a small amount, for example, ±6 millimeters from either side of a center line. This will, of course, also assist cutting and guillotining across the device in stacks of typically 500 sheets.

While various embodiments of the inventive security device 12 have been described herein, it should be understood that they have been presented by way of example only, and not limitation. For example, the durable tactile marking(s) described herein may be applied directly to a surface of a fibrous or non-fibrous sheet material used in the manufacture of secure documents (e.g., banknotes, bonds, checks, traveler's checks, identification cards, lottery tickets, passports, postage stamps, and stock certificates), as well as non-secure documents (e.g., labels). Thus, the breadth and scope of the present invention should not be limited by any of the exemplary embodiments.

What is claimed is:

1. A durable tactile marking comprising one or more relief structures selected from the group of elastically deformable relief structures, relatively compression-resistant relief structures, and combinations thereof, wherein the durable tactile marking is applied directly to a surface of a fibrous sheet material for use in making secure and non-secure documents or labels, or to a surface of a substrate and then mounted on a surface of the sheet material and/or at least partially embedded therein.

2. The durable tactile marking of claim 1, which comprises one or more elastically deformable relief structures.

3. The durable tactile marking of claim 2, wherein the one or more elastically deformable relief structures have a Durometer 00 (Shore 00) hardness of at least about 50, a Durometer A (Shore A) hardness of less than about 100, and a Young's Modulus of from about 0.3 to about 13.8 megapascals.

4. The durable tactile marking of claim 3, wherein the one or more elastically deformable relief structures are thermoplastic polyurethane relief structures.

5. The durable tactile marking of claim 1, which comprises one or more relatively compression-resistant relief structures.

6. The durable tactile marking of claim 5, wherein the one or more relatively compression-resistant relief structures have a Durometer A (Shore A) hardness of at least about 80, and a Young's Modulus of from about 3.4 to about 173 megapascals.

7. The durable tactile marking of claim 6, wherein the one or more relatively compression-resistant relief structures are thermosetting urethane-acrylate relief structures.

8. A security device for mounting on a surface of, or for at least partially incorporating in, a fibrous sheet material for use in making secure and non-secure documents or labels, which comprises a substrate and at least one durable tactile marking positioned on at least one surface of the substrate, wherein the at least one durable tactile marking is in the form of one or more relief structures, the one or more relief structures selected from the group of elastically deformable relief structures, relatively compression-resistant relief structures, and combinations thereof.

9. The security device of claim 8, wherein the at least one durable tactile marking is in the form of one or more elastically deformable relief structures.

10. The security device of claim 9, wherein the one or more elastically deformable relief structures have a Durometer 00 (Shore 00) hardness of at least about 50, a Durometer A (Shore A) hardness of less than about 100, and a Young's Modulus of from about 0.3 to about 13.8 megapascals.

11. The security device of claim 10, wherein the one or more elastically deformable relief structures are thermoplastic polyurethane relief structures.

12. The security device of claim 8, wherein the at least one durable tactile marking is in the form of one or more relatively compression-resistant relief structures.

13. The security device of claim 12, wherein the one or more relatively compression-resistant relief structures have a Durometer A (Shore A) hardness of at least about 80, and a Young's Modulus of from about 3.4 to about 173 megapascals.

14. The durable tactile marking of claim 13, wherein the one or more relatively compression-resistant relief structures are thermosetting urethane-acrylate relief structures.

15. The security device of claim 8, wherein the one or more relief structures are integrated or combined with one or more visually apparent and/or machine detectable security features.

16. The security device of claim 15, wherein the one or more visually apparent and/or machine detectable security features are selected from the group of magnetic security features, metal or metallic security features, and combinations thereof.

17. The security device of claim 15, wherein the one or more visually apparent and/or machine detectable security features are micro-optic security features, which comprise an arrangement of image icons and an arrangement of image icon focusing elements, wherein the arrangement of image icon focusing elements is disposed in relation to the arrangement of image icons at a distance sufficient for at least a portion of the image icon focusing elements to form at least one synthetically magnified image of at least a portion of the image icons.

18. The security device of claim 17, wherein the one or more relief structures are positioned directly on the arrangement of image icon focusing elements, directly on the arrangement of the image icons, or directly on both the arrangement of image icon focusing elements and the arrangement of image icons.

19. A fibrous sheet material for use in making secure and non-secure documents or labels, which has opposing surfaces and which comprises at least one durable tactile marking in the form of one or more relief structures, the one or more relief structures selected from the group of elastically deformable relief structures, relatively compression-resistant relief structures, and combinations thereof.

20. The fibrous sheet material of claim 19, wherein the one or more relief structures are positioned on one or opposing surfaces of the sheet material.

21. The fibrous sheet material of claim 19, which comprises one or more security devices mounted on a surface thereof and/or at least partially embedded therein, the one or more security devices comprising a substrate and at least one durable tactile marking positioned on at least one surface of the substrate, wherein the at least one durable tactile marking is in the form of one or more relief structures, the one or more relief structures selected from the group of elastically deformable relief structures, relatively compression-resistant relief structures, and combinations thereof.

22. A document made from the fibrous sheet material of claim 19.

23. The document of claim 22, which comprises a secure document selected from the group of banknotes, bonds, checks, traveler's checks, identification cards, lottery tickets, passports, postage stamps, and stock certificates.

24. The document of claim 23, which comprises a banknote.

25. The document of claim 22, which comprises a non-secure document.

26. The document of claim 25, which comprises a label.

27. The fibrous sheet material of claim 19, wherein the at least one durable tactile marking is tactilely discernible on both surfaces of the fibrous sheet material.

28. A document made from the fibrous sheet material of claim 20.

29. A document made from the fibrous sheet material of claim 21.

30. A document made from the fibrous sheet material of claim 27.
